(19) United States
(12) Patent Application Publication
(10) Pub. No.: US 2007/0250790 A1
(43) Pub. Date: Oct. 25, 2007

(54) Graphic user interface and establishing method thereof

(75) Inventor: Ming-Te Liu, Taipei City (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/729,857

(22) Filed: Mar. 30, 2007

(30) Foreign Application Priority Data
Apr. 24, 2006 (TW) 095114543

(51) Int. Cl. G06F 3/048

(52) U.S. Cl. 715/804

(57) ABSTRACT

A graphic user interface and an establishing method thereof are provided. Firstly, a first window is established. The first window has a window pattern and the first window is established by merging the window pattern with a desktop pattern of a desktop. Next, a second window is established. The second window is shown on the first window, and has a linking connection with the first window. The linking connection includes a relative position connection and a relative size connection. Then, a plurality of third windows are established. The third windows are shown on the second window, and have a plurality of implied connections with the second window respectively. The implied connections are established by an operation system. When the first window performs an action, the second window performs the action according to the linking connection, and the third windows are shown on the second window according to the implied connections.

This application claims the benefit of Taiwan application Serial No. 095114543, filed Apr. 24, 2006, the subject matter of which is incorporated herein by reference.

### BACKGROUND OF THE INVENTION

1. Field of the Invention

The invention relates in general to a graphic user interface and an establishing method thereof, and more particularly to a graphic user interface, inserting a second window between a plurality of third windows and a first window having marginal shadow, and an establishing method thereof.

2. Description of the Related Art

A computer system or a portable electronic device normally has an operation screen for the user to operate with. The graphic user interface (GUI) uses a patterned control button and a window frame as a communication interface between the screen and the user. Compared with the command line interface (CLI), the graphic user interface enables the user to input commands to the computer system by clicking the patterned control button with a mouse without having to remember complicated commands, and further enables the computer system to output various information. Therefore, the graphic user interface (GUI) has become a mainstream user interface for computer systems and software products. Besides, the graphic user interface (GUI) can form a shadow pattern at the margin of the window and make the window more stereo. The formation of conventional graphic user interface with stereo shadowed window is disclosed below.

Referring to FIGS. 1A˜1C, flowcharts of an establishing method of a conventional graphic user interface are shown. Firstly, as indicated in FIG. 1A, a first window 810 is established on a desktop 900. The first window 810 includes a body portion 811 and a marginal portion 812. The desktop 900 has a desktop pattern 900a. The body portion 811 has a body pattern 811a. The marginal portion 812 has a marginal pattern 812a. The first window 810 is established by merging the body pattern 811a and the marginal pattern 812a with the desktop pattern 900a respectively. The body portion 811 is established at the central position of the first window 810 by merging the body pattern 811a of a first ratio with the desktop pattern 900a of a second ratio according to an a blending function. The marginal portion 812 is established at the marginal position of the first window 810 by merging the marginal pattern 812a of the first ratio with the desktop pattern 900a of the second ratio according to the α blending function. The sum of the first ratio and the second ratio equals to 100%.

The first ratio corresponding to the body portion 811 is 100%. That is, the first window 810 forms the body portion 811 by merging the body pattern 811a of the first ratio 100% with the desktop pattern 900a of second ratio 0%. The first ratio corresponding to the marginal portion 812 diminishes outwardly from 100% to 0%. That is, the first window 810 forms the marginal portion 812 by merging the marginal pattern 812a which diminishes outwardly from the first ratio of 100% to 0% with the desktop pattern 900a which increases outwardly from the second ratio of 0% to 100%.

Next, as indicated in FIG. 1B and FIG. 1C, a plurality of second windows 820 are established on the first window 810. The body portion 811 of the first window 810 is formed by the body pattern 811a of the first ratio of 100%. If the second window 820 is established on the first window 810 by an operating system (OS), the second window 820 will be covered by the body pattern 811a of the first window 810 and can not be viewed by the user. Therefore, the second window 820 has to be added on the first window 810 for being viewed by the user, such that the first window 810 and the second window 820 are two independent windows.

Referring to FIG. 1B, the first window 810 and the second window 820 are two independently operated windows. Therefore, a linking connection L01 is established between the first window 810 and the second window 820. The linking connection L01 includes a relative position connection and a relative size connection between the first window 810 and the second window 820. The linking connection L01 is external to a software program, not established by an operating system (OS). As indicated in FIG. 1C, a graphic user interface (GUI) 800 is formed.

Referring to FIG. 2A˜2C, perspectives showing the movement of a conventional graphic user interface are shown. As indicated in FIG. 2A, the first window 810 is at a first position P1, the user asks the first window 810 to move to a second position P2 from the first position P1. Next, as indicated in FIG. 2B and FIG. 2C, during the movement of the first window 810, the second window 820 does not synchronize with the first window 810. The second window 820 has to wait until the first window 810 is moved to the second position P2, the body portion 811 and the marginal portion 812 are merged with the desktop pattern 900a, and the computer system has captured the correct position of the first window 810, before the second window 820 is able to move and display according to the new position of the first window 810. Therefore, during the movement of the first window 810, image delay will occur to the first window 810 and the second window 820 due to the delay of the merging procedure as indicated in FIG. 2B. The image delay is indeed very annoying to the user. Besides, similar problems will occur when the user asks the first window 810 to perform other actions, such as window resizing, window closing, window maximizing or window minimizing, and the merging procedure has to be performed. Conventional graphic user interface whose window has shadowed margin has the following disadvantages.

Firstly, image delay occurs. As the first window moves, resizes or perform other actions, a plurality of second windows do not synchronize with the first window. The second windows can not perform corresponding actions according to the linking connection until the first window has completed the merging procedure and captured the correct position of the first window. Consequently, image delay occurs during the action of the first window.

Secondly, system resources are wasted. As the first window performs an action, the second windows perform respective actions according to the linking connection. Therefore, the computer system has to process each of the second windows individually, which wastes a large amount of system resources.

Thirdly, the reaction is slow. As the computer system has to process the second windows individually, the computer system normally has to spend 1˜2 seconds to complete the whole actions of the second window, hence slowing down the reaction speed of the graphic user interface.

Therefore, how to resolve the above problems has become an imminent issue to be resolved.

### SUMMARY OF THE INVENTION

The invention is directed to a graphic user interface. A second window is inserted between a plurality of third windows and a first window, a linking connection external to software programs is established between the first window and the second window, and a plurality of implied connections established by an operating system (OS) are introduced between the second window and the third windows, so that the graphic user interface overcomes several problems that can not be resolved in conventional practices, and further possesses the advantages of no image delay, mitigation of system resources, and fast reaction.

According to a first aspect of the present invention, a graphic user interface is provided. The graphic user interface is shown on a desktop having a desktop pattern. The graphic user interface includes a first window, a second window and a plurality of third windows. The first window has a window pattern. The first window is established by merging the window pattern with the desktop pattern. The second window is shown on the first window, and has a linking connection with the first window. The linking connection includes a relative position connection and a relative size connection between the first window and the second window. The third windows are shown on the second window, and have a plurality of implied connections with the second window respectively. The implied connections are established by an operation system. When the first window performs an action, the second window performs the action according to the linking connection, and the third windows are shown on the second window according to the implied connections.

According to a second aspect of the present invention, an establishing method of graphic user interface for displaying a graphic user interface on a desktop is provided. The desktop has a desktop pattern. The establishing method includes the following steps. Firstly, a first window is established, wherein the first window has a window pattern. The first window is established by merging the window pattern with the desktop pattern. Next, a second window is established, wherein the second window is shown on the first window, and has a linking connection with the first window. The linking connection includes a relative position connection and a relative size connection between the first window and the second window. Then, a plurality of third windows are established, wherein the third windows are shown on the second window, and have a plurality of implied connections with the second window respectively. The implied connections are established by an operation system. When the first window performs an action, the second window performs the action according to the linking connection, and the third windows are shown on the second window according to the implied connections.

The invention will become apparent from the following detailed description of the preferred but non-limiting embodiments. The following description is made with reference to the accompanying drawings.

### BRIEF DESCRIPTION OF THE DRAWINGS

FIGS. 1A˜1C (Prior Art) are flowcharts of an establishing method of a conventional graphic user interface;

FIGS. 2A˜2C (Prior Art) are perspectives showing the movement of a conventional graphic user interface;

FIG. 3 is a perspective of a graphic user interface according to an embodiment of the invention;

FIG. 4 is a flowchart of an establishing method of graphic user interface according to an embodiment of the invention;

FIGS. 5A˜5D are perspectives showing the steps of FIG. 4; and

FIG. 6 is a reference table of the body portion and the marginal portion of the first window vs. the first ratio and the second ratio.

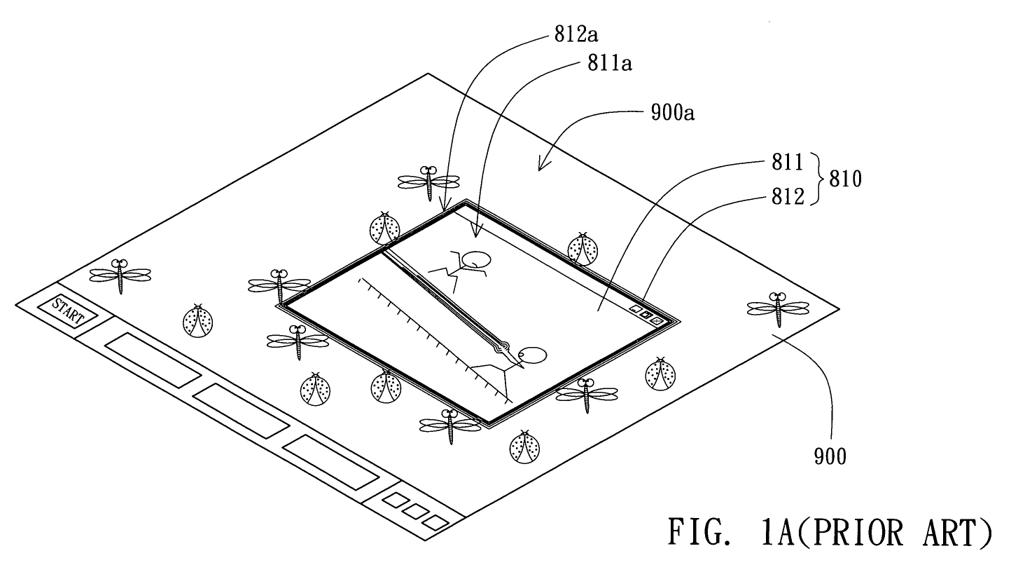

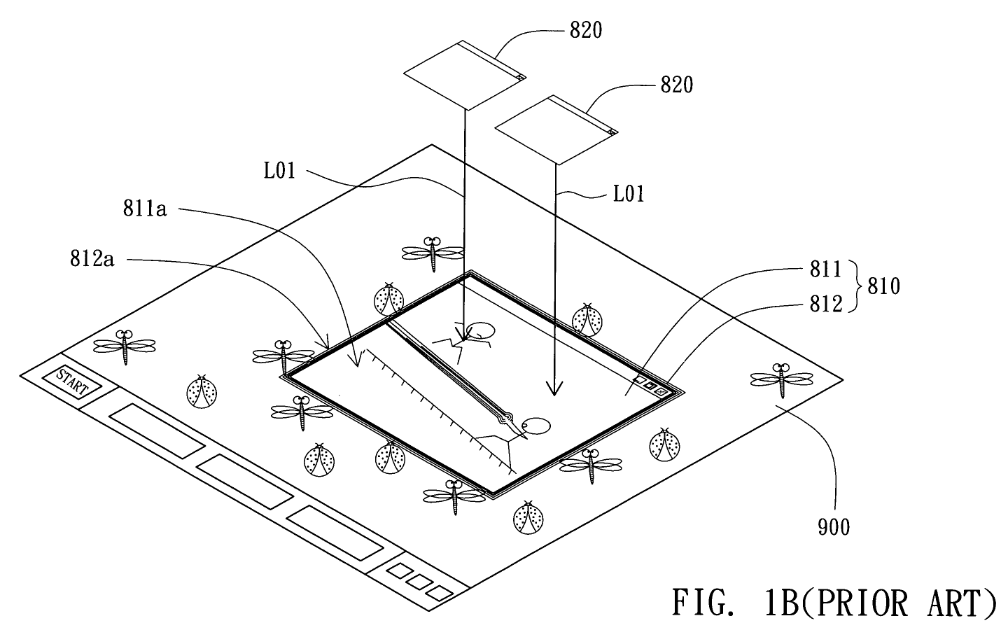

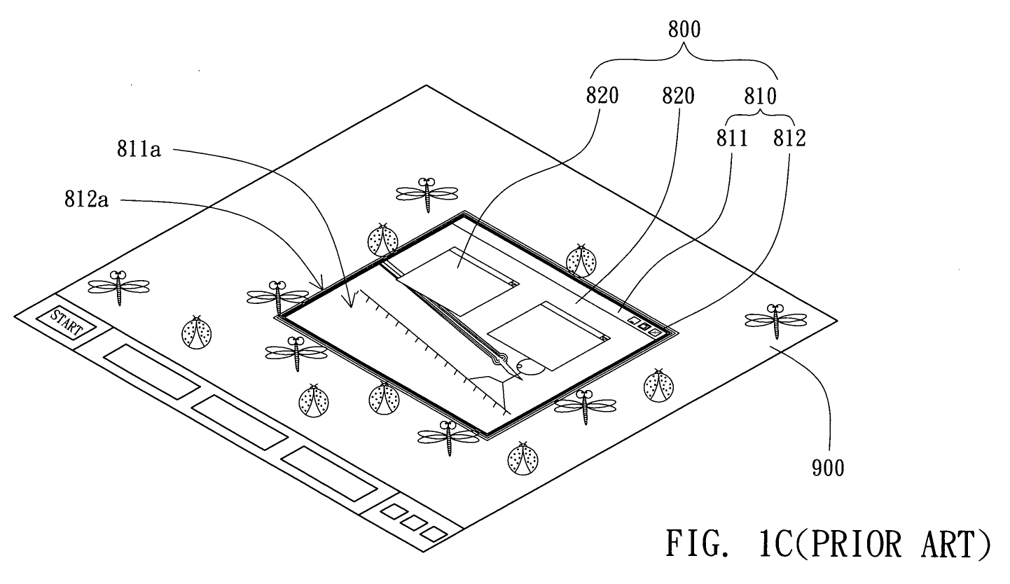

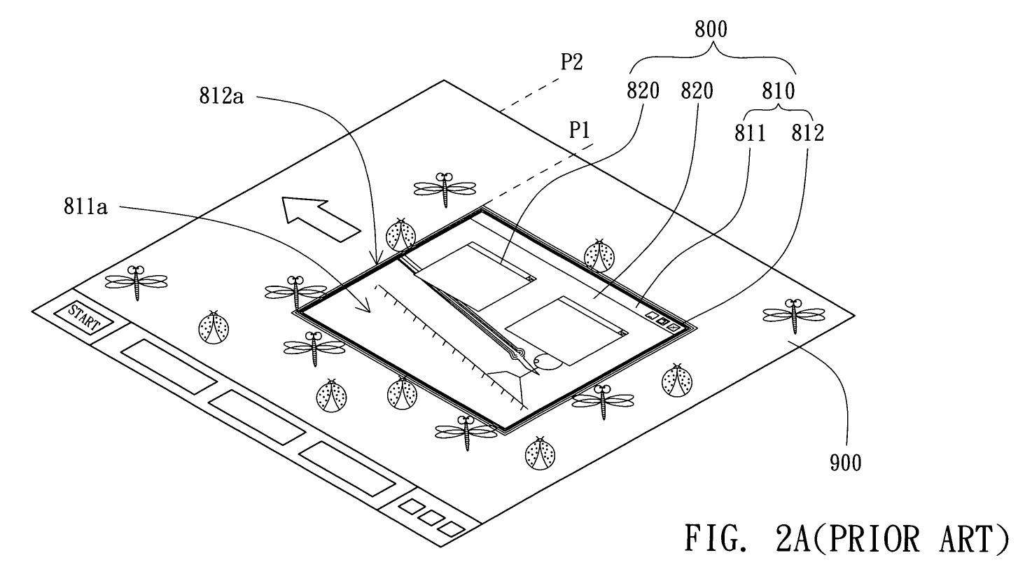

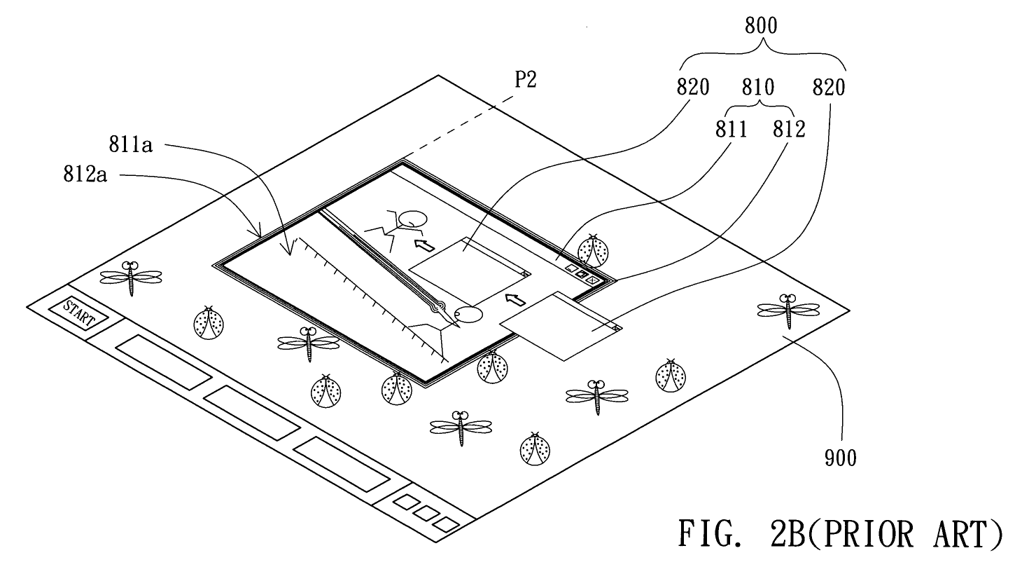

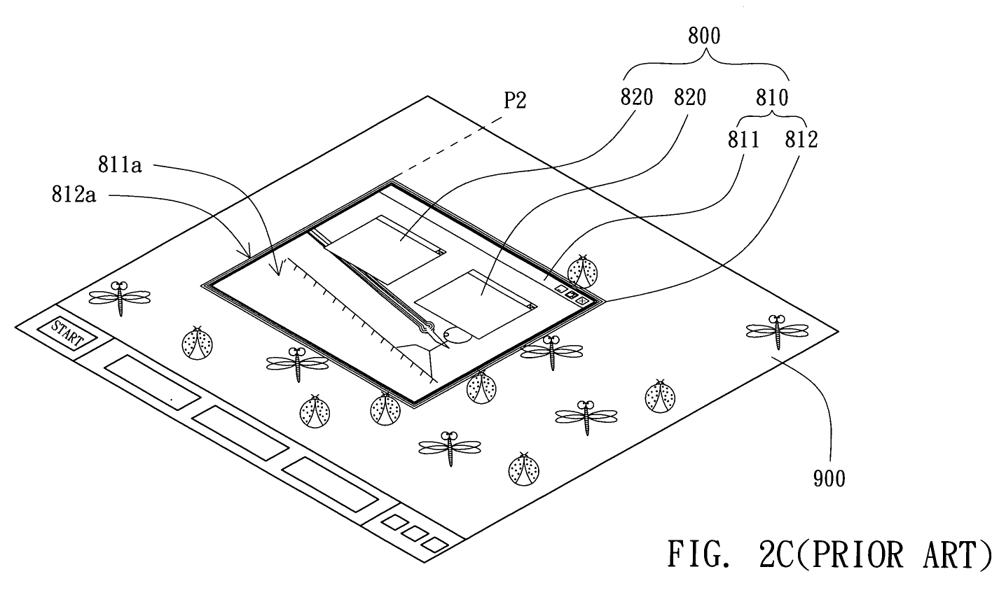

### DETAILED DESCRIPTION OF THE INVENTION

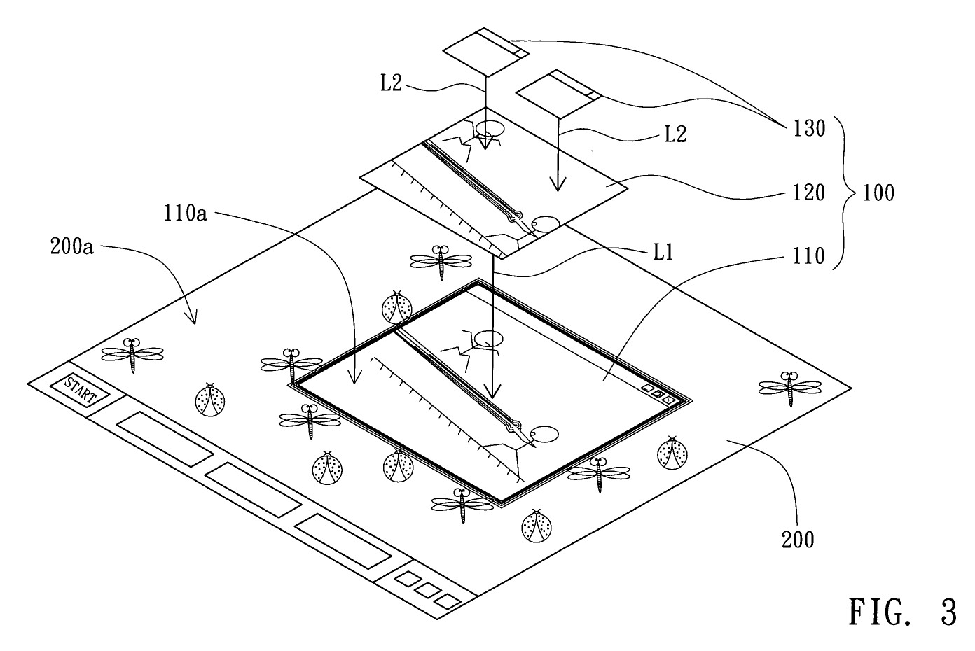

Referring to FIG. 3, a perspective of a graphic user interface according to an embodiment of the invention is shown. The graphic user interface (GUI) 100 is shown on a desktop 200 having a desktop pattern 200a. The graphic user interface 100 includes a first window 110, a second window 120 and a plurality of third windows 130. The first window 110 has a window pattern 110a. The first window 110 is established by merging the window pattern 110a with the desktop pattern 200a. The second window 120 is shown on the first window 110, and has a linking connection L1 with the first window 110. The linking connection L1 includes a relative position connection and a relative size connection between the first window 110 and the second window 120. The third windows 130 are shown on the second window 120, and have a plurality of implied connections L2 with the second window 120 respectively. The implied connections L2 are established by an operating system (OS).

As disclosed above, the second window 120 is inserted between a plurality of third windows 130 and the first window 110. A linking connection L1 external to software programs is introduced between the first window 110 and the second window 120. The second window 120 has the implied connections L2 established by an operating system (OS) with the third windows 130. When the first window 110 performs an action, the second window 120 performs the action according to the linking connection L1, and the third windows 130 are displayed on the second window 120 according to the implied connections L2.

Since the implied connections L2 established by the operating system are introduced between the third windows 130 and the second window 120, when the second window 120 performs an action, all of the third windows 130 synchronize with the second window 120 promptly without waiting for the merging procedure that merges the first window 110 with the desktop 200 to be completed. Therefore, when the first window 110 performs an action, the computer system merely needs to perform a corresponding action to one second window 120 only according to the linking connection L1. The third windows 130 react to the second window 120 promptly and are displayed on the second window 120 according to the implied connections L2, hence avoiding the problem of image delay.

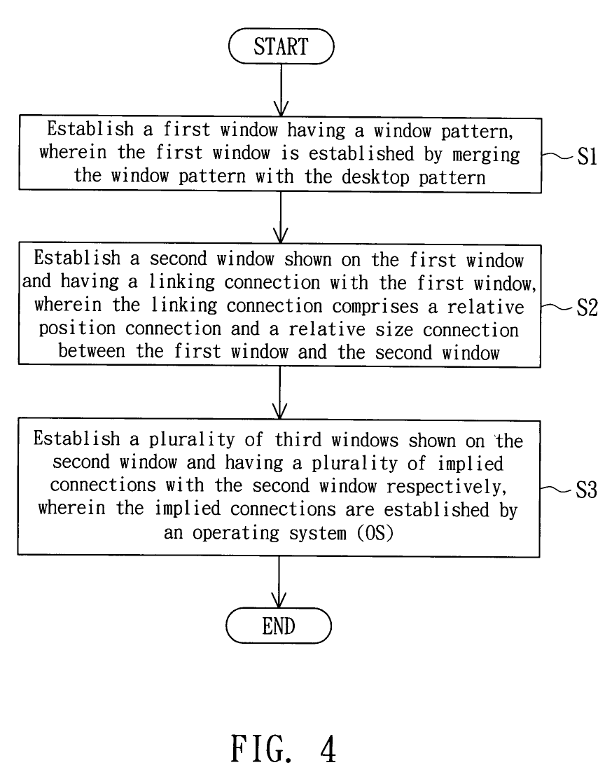

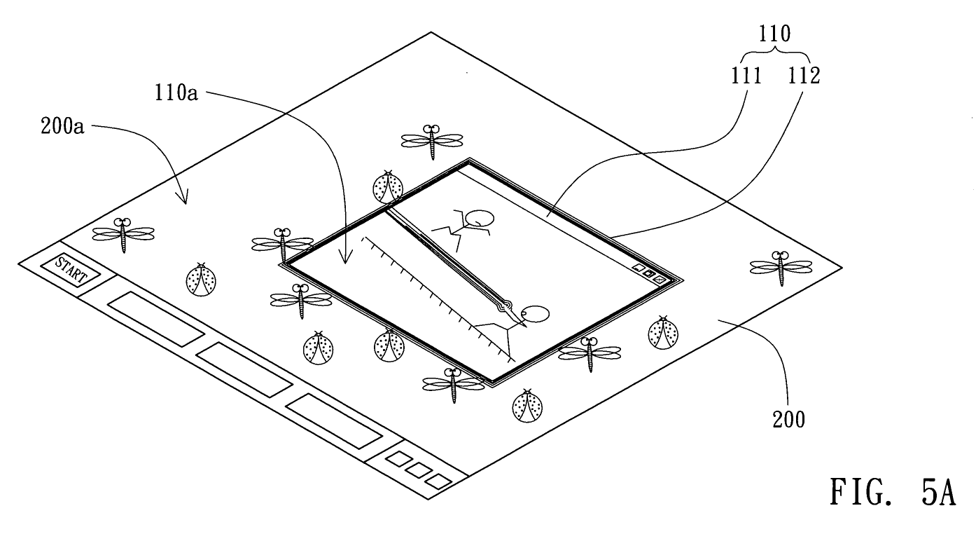

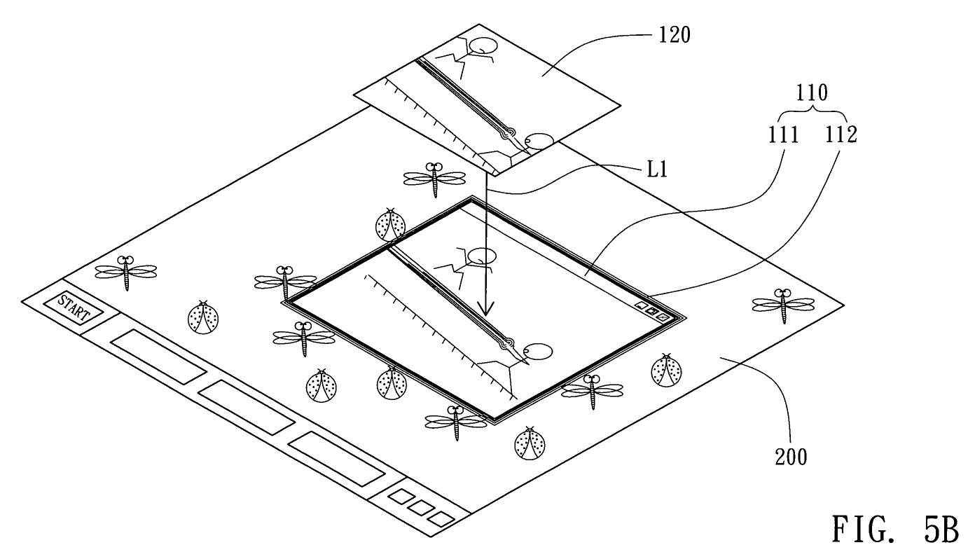

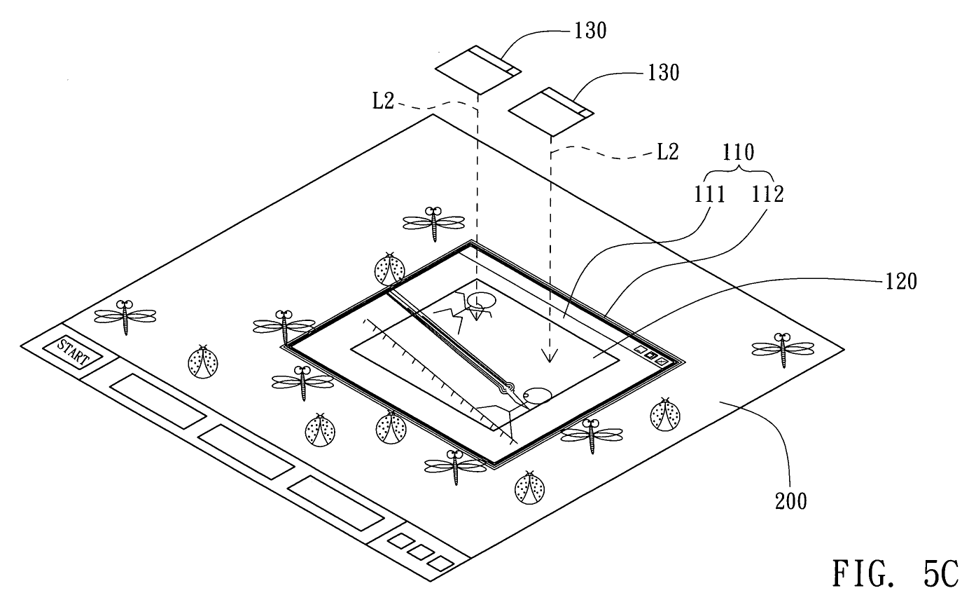

The formation of the graphic user interface 100 is elaborated in FIG. 4 and FIGS. 5A˜5D. FIG. 4 is a flowchart of an establishing method of graphic user interface of the embodiment of the invention. FIG. 5A˜5D are perspectives showing the steps of FIG. 4.

Firstly, the method begins at step S1 of FIG. 4. As indicated in FIG. 5A, the first window 110 having a window pattern 110a is established by merging the window pattern 110a with a desktop pattern 200a of the desktop 200.

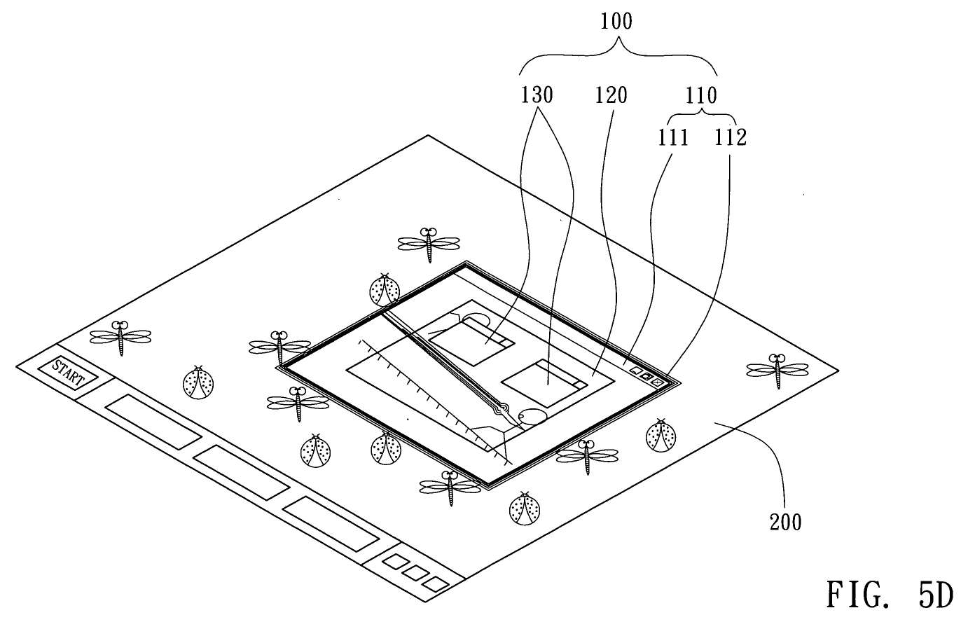

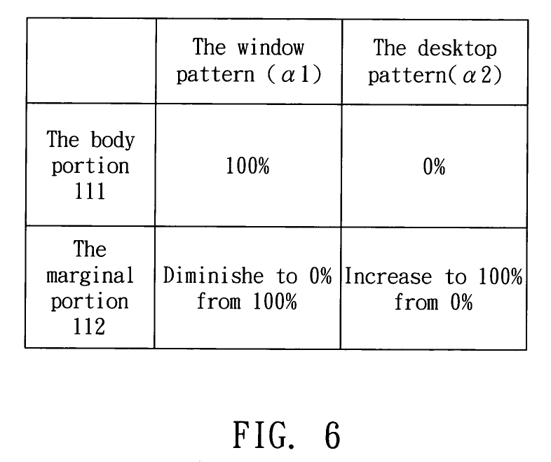

Referring to FIG. 6, a reference table of the body portion and the marginal portion of the first window vs. the first ratio and the second ratio is shown. The first window 110 is generated by merging the window pattern 110a of a first ratio al with the desktop pattern 200a of a second ratio α2 according to an a blending function. The sum of the first ratio α1 and the second ratio α2 equals 100%. The step of establishing the first window 110 further comprises the following sub-steps.

Firstly, a body portion 111 of the first window 110 is established. The first ratio α1 corresponding to the body portion 111 is the first percentage, such as 100% for example, and the second ratio α2 corresponding to the body portion 111 is the second percentage, such as 0% for example. In other words, the body portion 111 is established by merging the window pattern 110a of 100% with the desktop pattern 200a of 0%.

Next, a marginal portion 112 of the first window 110 is established. The first ratio α1 corresponding to the marginal portion 112 forms the first percentage (100%) that diminishes outwardly to the second percentage (0%), and the second ratio α2 corresponding to the marginal portion 112 forms the second percentage (0%) that increases outwardly to the first percentage (100%). In other words, the marginal portion 112 gradually develops into the desktop pattern 200a from the window pattern 110a inside out. For the first window 110 to have a three-dimensional shadow, the window pattern 110a positioned at the marginal portion 112 is a preset color pattern in dark colors such as a black pattern for example. To be more precisely, the marginal portion 112 gradually develops into the desktop pattern 200a inside out from a black pattern.

Next, the method proceeds to step S2 of FIG. 4. As indicated in FIG. 5B, the second window 120 is established. The second window 120 is shown on the first window 110, and has a linking connection L1 with the first window 110. The linking connection L1 includes a relative position connection and a relative size connection between the first window 110 and the second window 120. The second window 120 is a pop-up window with respect to the first window 110, such that the second window 120 can be displayed on the first window 110 without being covered by the window pattern 110a of the first window 110.

Then, the method proceeds to step S3 of FIG. 4. As indicated in FIG. 5C, the third windows 130 are established. The third windows 130 are shown on the second window 120, and have a plurality of implied connections L2 with the second window 120. The implied connections L2 are established by an operating system (OS). As indicated in FIG. 5D, after the third windows 130 are loaded on the second window 120, the graphic user interface 100 is established.

Referring to both FIG. 3 and FIG. 5D. When the first window 110 performs an action, the second window 120 perform the action according to the linking connection L1, and the third windows 130 are displayed on the second window 120 according to implied connections L2. The action includes window moving, window resizing, window closing, window maximizing or window minimizing.

For example, when the first window 110 moves, the computer system merely needs to move only one second window 120 according to the relative position connection of the linking connection L1. The third windows 130 react promptly to the second window 120, and are displayed on the second window 120 according to the implied connections L2 without waiting for the first window 110 to be merged with the desktop 200. Therefore, image delay will not occur during the movement of the first window 110.

Another example is taken for elaboration. When the first window 110 resizes, the computer system merely needs to resize only one second window 120 according to the relative position connection and the relative size connection of the linking connection L1. The third windows 130 react to the second window 120 promptly, and are displayed on the second window 120 according to the implied connections L2 without waiting for the first window 110 to be merged with the desktop 200. Therefore, the problem of image delay will not occur during the resizing of the first window 110, and the resources of the computer system are mitigated.

During the above actions of the graphic user interface 100, the procedure of merging the first window 110 with the desktop 200 is performed after the third windows 130 are displayed on the second window 120; or the step of displaying the third windows 130 on the second window 120 and the merging procedure are performed at the same time, hence the graphic user interface 100 is free of image delay.

According to the above embodiment, despite the relationship between the first window and the desktop of the invention is exemplified by the relationship of merging a shadow; however the first window can have other operating relationships with the desktop of the invention. As long as a plurality of windows are loaded on the first window by independent operations, any technologies used to insert a second window, establish a linking connection external to a software program and a plurality implied connections built in an operating system so to achieve the object of the invention are still within the scope of technology of the invention.

According to the patterned operation interface and an establishing method thereof disclosed in the above embodiment of the invention, a second window is inserted between a plurality of third windows and the first window, a linking connection external to software programs is established between the first window and the second window, and a plurality of implied connections established by an operating system (OS) are introduced between the second window and the third windows, such that the graphic user interface overcomes several problems encountered in conventional practices and further possesses the following advantages.

Firstly, image delay is avoided. After the first window moves, resizes or performs other actions, the second window performs a corresponding action according to the linking connections. The third windows can synchronize with the second window according to the implied connections without waiting for the first window to be merged with the desktop. Therefore, the graphic user interface will not result in image delay.

Secondly, system resources are mitigated. When the first window performs an action, the computer system merely needs to perform a corresponding action to one second window only, not each of the third windows, according to the linking connection. Therefore, the graphic user interface of the invention largely reduces the burden of system resources.

Thirdly, the reaction is fast. As the computer system merely needs to process one second window only, and the third windows react promptly according to the implied connections, so the reaction of the graphic user interface is prompt and fast.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A graphic user interface (GUI) established on a desktop having a desktop pattern, the graphic user interface comprising:
a first window having a window pattern, wherein the first window is established by merging the window pattern with the desktop pattern;
a second window shown on the first window and having a linking connection with the first window, wherein the linking connection comprises a relative position connection and a relative size connection between the first window and the second window; and
a plurality of third windows shown on the second window and having a plurality of implied connections with the second window respectively, wherein the implied connections are established by an operating system (OS);
wherein when the first window performs an action, the second window performs the action according to the linking connection, and the third windows are shown on the second window according to the implied connections.

2. The graphic user interface according to claim 1, wherein the first window is generated by merging the window pattern of a first ratio with the desktop pattern of a second ratio, the first window comprising:
a body portion, wherein the first ratio corresponding to the body portion is a first percentage; and
a marginal portion disposed at the peripheral of the body portion, wherein the first ratio corresponding to the marginal portion diminishes outwardly to a second percentage from the first percentage.

3. The graphic user interface according to claim 2, wherein the window pattern positioned at the marginal portion is a preset color pattern.

4. The graphic user interface according to claim 1, wherein the first window is established by merging the window pattern with the desktop pattern according to an α blending function.

5. The graphic user interface according to claim 1, wherein the second window is a pop-up window with respect to the first window.

6. The graphic user interface according to claim 1, wherein the action is one of window moving, window resizing, window closing, window maximizing and window minimizing.

7. The graphic user interface according to claim 6, wherein when the first window moves, the second window moves according to the relative position connection, and the third windows are shown on the second window according to the implied connections.

8. The graphic user interface according to claim 6, wherein when the first window resizes, the second window resizes according to the relative position connection and the relative size connection, and the third windows are shown on the second window according to the implied connections.

9. The graphic user interface according to claim 1, wherein the first window is generated by merging the window pattern of a first ratio with the desktop pattern of a second ratio according to a merging procedure.

10. The graphic user interface according to claim 9, wherein after the third windows are displayed on the second window, the merging procedure is performed.

11. The graphic user interface according to claim 1, wherein the action changes the relative position connection or the relative size connection, so that the third windows are correspondingly displayed on the second window according to the changed relative position connection and the changed relative size connection.

12. An establishing method of graphic user interface (GUI) for establishing a graphic user interface on a desktop having a desktop pattern, the establishing method comprising:
establishing a first window having a window pattern, wherein the first window is established by merging the window pattern with the desktop pattern;
establishing a second window shown on the first window and having a linking connection with the first window, wherein the linking connection comprises a relative position connection and a relative size connection between the first window and the second window; and
establishing a plurality of third windows shown on the second window and having a plurality of implied connections with the second window respectively, wherein the implied connections are established by an operating system (OS);
wherein when the first window performs an action, the second window performs the action according to the linking connection, and the third windows are shown on the second window according to the implied connections.

13. The establishing method of graphic user interface according to claim 12, wherein the first window is established by merging the window pattern of a first ratio with the desktop pattern of a second ratio according to an α blending function from, the step of establishing the first window further comprises:
establishing a body portion of the first window, wherein the first ratio corresponding to the body portion is a first percentage; and
establishing the marginal portion of the first window, wherein the first ratio corresponding to the marginal portion diminishes outwardly to a second percentage from the first percentage.

14. The establishing method of graphic user interface according to claim 13, wherein the window pattern positioned at the marginal portion is a preset color pattern.

15. The establishing method of graphic user interface according to claim 12, wherein in the step of establishing the second window, the second window is a pop-up window with respect to the first window.

16. The establishing method of graphic user interface according to claim 12, wherein the action is one of window moving, window resizing, window closing, window maximizing and window minimizing.

17. The establishing method of graphic user interface according to claim 16, wherein when the first window moves, the second window moves according to the relative position connection, and the third windows are shown on the second window according to the implied connections.

18. The establishing method of graphic user interface according to claim 16, wherein when the first window resizes, the second window resizes according to the relative position connection and the relative size connection, and the third windows are shown on the second window according to the implied connections.

19. The establishing method of graphic user interface according to claim 12, wherein the step of establishing the first window comprises:
generating the first window by merging the window pattern of a first ratio with the desktop pattern of a second ratio according to a merging procedure.

20. The establishing method of graphic user interface according to claim 19, wherein after the third windows are displayed on the second window, the merging procedure is performed.
